(19) United States
(12) Patent Application Publication
(10) Pub. No.: US 2021/0379789 A1
(43) Pub. Date: Dec. 9, 2021

(54) METHOD FOR FRACTURING METAL COMPONENT, AND METHOD FOR FRACTURING CONNECTING ROD

(71) Applicant: YASUNAGA CORPORATION, Iga-shi, Mie (JP)

(72) Inventors: Hiroichi HASE, Mie (JP); Yuji KAIMASU, Mie (JP)

(21) Appl. No.: 17/250,985

(22) PCT Filed: Nov. 20, 2019
(86) PCT No.: PCT/JP2019/045460

§ 371 Date: Apr. 7, 2021

(30) Foreign Application Priority Data
Nov. 30, 2018 (JP) 2018-224821

(51) Int. Cl. B26F 3/02; F16C 7/02

(52) U.S. Cl. CPC B26F 3/02; F16C 7/023

(57) ABSTRACT

A method for fracturing a metal component in which a through hole is included, and groove portions that continue from a first open end to a second open end of the through hole are formed at facing positions in an inner circumferential surface of the through hole, includes specifying positions on which a stress is to concentrate when fracturing of the metal component is started, in the groove portions of the metal component; forming stress concentration portions at positions in bottom portions of the groove portions corresponding to the specified positions such that the specified positions in the groove portions are caused to serve as breaking start points; and causing cracking earlier at the stress concentration portions in the groove portions than at each portion of the groove portions when the fracturing is started and causing cracking to develop from each portion of the groove portions.

### CROSS-REFERENCE TO RELATED APPLICATION (S)

This Application is a Section 371 National Stage Application of International Application No. PCT/JP2019/045460, filed Nov. 20, 2019 and published as WO 2020/110861 A1 on Jun. 4, 2020, and further claims priority to Japanese Application Ser. No. 2018-224821, filed Nov. 30, 2018.

### TECHNICAL FIELD

The present invention relates to a method for fracturing a metal component and a method for fracturing a connecting rod in which fracturing is started from a through hole.

### BACKGROUND ART

In regard to metal components including through holes, components fractured and split from the through holes are combined and used as pairs of products in some cases. As representative metal components, connecting rods (hereinafter, referred to as con-rods) are known.

For con-rods, it is possible to precisely perform positioning even in a state in which positioning pins are omitted when main body portions and cap portions are fastened with bolts, by applying loads in an expanding direction to the through holes at large end portions, fracturing and splitting the large end portions into the main body portions and the cap portions, and using irregularity generated in the fractured surfaces for the positioning.

Many con-rods are adapted such that the large end portions are fractured from groove portions by forming the groove portions to continue from open ends on one side to open ends on the other side at facing parts in inner circumferential surfaces of the through holes of the large end portions.

However, since multiple breaking start points are present in the groove portions, cracking developing from multiple directions may interfere with each other, cracking may advance with three-dimensional deviations, and satisfactory fractured surfaces may not be obtained merely by the groove portions formed in the con-rods.

Thus, a technique of employing a method of forming a step difference portion as a stress concentration portion at an intermediate position between a groove portion and a fracturing termination position, for example, in an inner circumferential surface of a bolt hole, for example, to guide a direction in which cracking advances with the step difference portion, and thereby to curb three-dimensional deviations of the cracking.

### PRIOR ART DOCUMENT

### Patent Document

Patent Document 1: Japanese Patent Laid-Open No. 2014-98423

### SUMMARY OF THE INVENTION

### Problems to be Solved by the Invention

However, since there is no other choice than disposing the stress concentration portion at an intermediate location between the groove portion and the fracturing termination position, formation of the stress concentration portion is burdensome. Even in a case in which the step difference portion is formed in the inner circumferential surface of the bolt hole and is caused to serve as the stress concentration portion, operations that are burdensome in terms of costs, such as formation of the bolt hole with a predetermined large diameter portion and a predetermined small diameter portion, are likely to be forced.

Thus, disclosed embodiments provide a method for fracturing a metal component and a method for fracturing a connecting rod that enables fracturing while forming satisfactory fractured surfaces that can curb three-dimensional deviations using a method of simply forming stress concentration portions.

### Means for Solving the Problems

An aspect of a method for fracturing a metal component according to a first invention is a method for fracturing a metal component in which a metal component including a predetermined through hole is included, and groove portions that continue from a first open end to a second open end of the through hole are formed at facing positions in an inner circumferential surface of the through hole, such that the metal component is able to be fractured from the groove portions, the method including: specifying positions, on which a stress is to concentrate when fracturing of the metal component is started, in the groove portions of the metal component; forming stress concentration portions at positions in bottom portions of the groove portions corresponding to the specified positions such that the specified positions in the groove portions are caused to serve as breaking start points; and causing cracking earlier at the stress concentration portions in the groove portions than at each portion of the groove portions when the fracturing of the metal component is started and causing cracking to develop from each portion of the groove portions.

According to the method, cracking occurs with the stress concentration portions in the groove portions serving as the earliest breaking start points when the fracturing of the metal component is started, and the cracking advances earliest to a finally fractured position of the metal component. Cracking develops from each portion in the groove portions with the advancement of the cracking and advances up to the finally fractured position. In other words, cracking from the groove portions satisfactorily advances up to the finally fractured position, and the metal component is fractured while forming satisfactory fractured surfaces with which three-dimensional deviations are curbed.

In an aspect of the method for fracturing a metal component according to a second invention, the stress concentration portions are formed by recessed portions. Therefore, it is only necessary to form the recessed portions at the bottom portions of the groove portions for the stress concentration portions.

An aspect of a method for fracturing a connecting rod according to a third invention is a method for fracturing a connecting rod, which is performed on a connecting rod that includes a large end portion including a through hole, in which groove portions that continue from a first open end to a second open end of the through hole are formed at facing positions in an inner circumferential surface of the through hole, such that the large end portion is able to be fractured from the groove portions, the method including: specifying positions, on which a stress is to concentrate when fracturing of the large end portion is started, in the groove portions of the large end portion; forming stress concentration portions at positions in bottom portions of the groove portions corresponding to the specified positions such that the specified positions in the groove portions are caused to serve as breaking start points; and causing cracking earlier at the stress concentration portions in the groove portions than at each portion of the groove portions when the fracturing of the large end portion is started and causing cracking to develop from each portion of the groove portions.

According to the method, cracking occurs with the stress concentration portions in the groove portions serving as the earliest breaking start points when the fracturing of the large end portion is started, and the cracking advances earliest to a finally fractured position of the large end portion. Cracking develops from each portion in the groove portions with the advancement of the cracking and advances up to the finally fractured position. In other words, cracking from the groove portions satisfactorily advances up to the finally fractured position, and the large end portion of the connecting rod is fractured while forming satisfactory fractured surfaces with which three-dimensional deviations are curbed.

In an aspect of the method for fracturing a connecting rod according to a fourth invention, the stress concentration portions are formed at positions in the bottom portions of the groove portions corresponding to points at which distances between bolt holes and the groove portions are the shortest. In this manner, cracking advances from specific positions in the groove portions using the bolt holes.

In an aspect of the method for fracturing a connecting rod according to a fifth invention, each of the stress concentration portions is formed at a position in the bottom portion of the groove portion corresponding to each point at which the distance between each of a plurality of aligned bolt holes and the groove portion is the shortest. In this manner, cracking advances from specific positions in the groove portions using the plurality of bolt holes.

In an aspect of the method for fracturing a connecting rod according to a sixth invention, the stress concentration portions are formed by recessed portions. In this manner, it is only necessary to form the recessed portions in the bottom portions of the groove portions for the stress concentration portions.

### Advantageous Effects of the Invention

According to the present invention, it is possible to fracture a metal component and a connecting rod while forming satisfactory fractured surfaces with which three-dimensional deviations are curbed, by a simple method of forming the stress concentration portions in the groove portions (claims 1 and 3).

In particular, it is possible to cause cracking to advance earliest from specific positions in the groove portions when the fracturing is started using existing bolt holes, by specifying the positions at which the distances between the bolt holes and the groove portions are the shortest as the positions on which a stress is caused to concentrate and forming the stress concentration portions in the bottom portions of the groove portions corresponding to the specified positions (claim 4). Also, even in a case in which a plurality of bolt holes are included, it is possible to cause cracking to efficiently advance while curbing three-dimensional deviations by forming the stress concentration portions corresponding to the bolt holes (claim 5). Moreover, it is only necessary to form the recessed portions in the bottom portions of the groove portions for the stress concentration portions, which is simple and requires less burden in terms of costs (claims 2 and 6).

The present summary is provided only by way of example, and not limitation. Other aspects of the present invention will be appreciated in view of the entirety of the present disclosure, including the entire text, claims and accompanying figures.

### BRIEF DESCRIPTION OF THE DRAWINGS

FIG. 1 is a front view illustrating a connecting rod that is a target of an aspect of a first embodiment of the present invention.

FIG. 2 is a perspective view illustrating a workpiece that is a metal component as a semi-finished product before a large end portion of the connecting rod is split.

FIG. 3A is a side view illustrating a groove portion and a stress concentration portion formed in the workpiece when seen from the arrow view X in FIG. 2.

FIG. 3B is a side view illustrating the groove portion and the stress concentration portion in an enlarged manner.

FIG. 4 is an arrow view illustrating the groove portion and the stress concentration portion when seen from the arrow view Y in FIG. 3B.

FIG. 5 is a plan view of the workpiece when seen from the arrow view Z in FIG. 3A.

FIG. 6 is a perspective view for explaining fracturing of the large end portion of the workpiece using an inner diameter expansion device.

FIG. 7A is an explanatory diagram for explaining an initial state when the large end portion of the workpiece is fractured.

FIG. 7B is an explanatory diagram for explaining a later state of the same.

FIG. 8 is a perspective view illustrating the fractured large end portion of the workpiece.

FIG. 9 is a sectional view for explaining how cracking occurs at the time of fracturing.

FIG. 10 is a perspective view illustrating a large end portion of a workpiece positioned and reassembled using irregularity caused in fractured surfaces.

FIG. 11 is a plan view illustrating an example in which a groove portion and a stress concentration portion are formed in a workpiece including two pairs of bolt holes according to an aspect of a second embodiment of the present invention.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps and/or components not specifically shown in the drawings.

### MODE FOR CARRYING OUT THE INVENTION

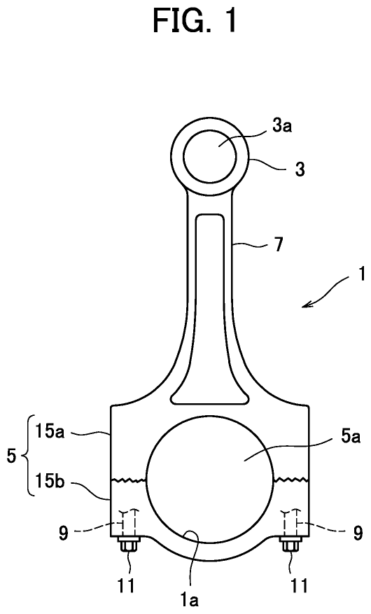

Hereinafter, the present invention will be described on the basis of a first embodiment illustrated in FIGS. 1 to 10.

FIG. 1 illustrates a front view of a connecting rod 1 (hereinafter, referred to as a con-rod 1) that is a product.

The con-rod 1 includes a small end portion 3 including a piston pin hole 3a, a large end portion 5 including a crank pin hole 5a (corresponding to the predetermined through hole in the present application), and a rod 7 coupling the small end portion 3 to the large end portion 5. Also, the large end portion 5 is provided with a pair of bolt holes 9 (one each on left and right sides) located on sides of the crank pin hole 5a. Moreover, the bolt holes 9 are formed by holes extending in a direction perpendicularly intersecting the crank pin hole 5a.

The large end portion 5 is split into a main body portion 15a and a semi-arc-shaped cap portion 15b such that a crank pin (not illustrated) can be sandwiched therebetween, and the cap portion 15b is fastened to the main body portion 16a with the crank pin sandwiched by a con-rod bolt 11 inserted into each bolt hole 9.

For splitting of such a con-rod 1, a fracturing method of applying a load in an expanding direction to the inner diameter (crank pin hole 5a) of the large end portion 5 using an inner diameter expansion device A, which will be described later, for example, and splitting the large end portion 5 into the main body portion 15a and the cap portion 15b is used. Irregularity generated in the fractured surfaces by the fracturing method is used to position the main body portion 15a and the cap portion 15b.

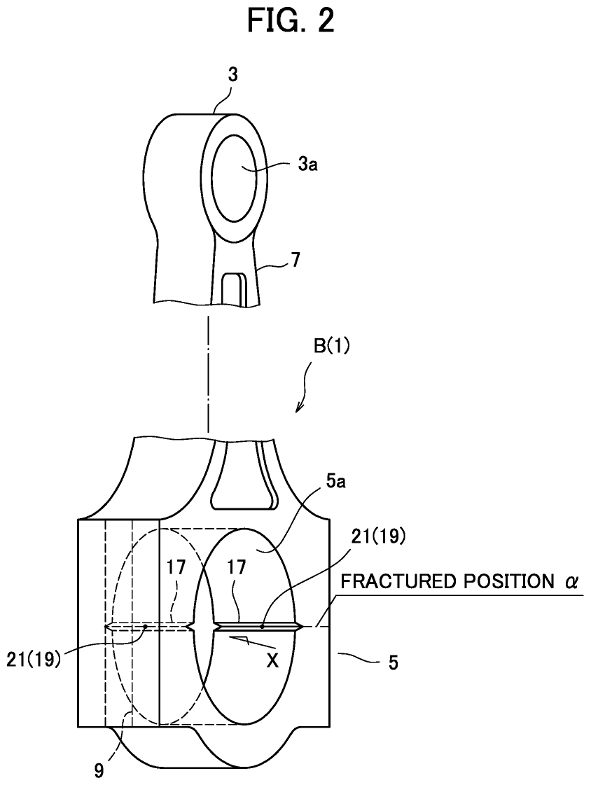

As a fracturing method, a method of forming groove portions, for example, V groove portions 17 with V-shaped sections continuously from one open end that is a first open end to the other open end that is a second open end of the crank pin hole 5a, at facing portions in the inner circumferential surface of the crank pin hole 5a in a semi-finished product of the con-rod 1 before fracturing, for example, a workpiece B that is the metal component that includes the small end portion 3 and the large end portion 5 as illustrated in FIG. 2, such that the large end portion 5 can be fractured from the V groove portions 17 is often used. “α” in FIG. 2 illustrates the fractured position (only the fractured position on one side is illustrated).

With this structure, there is a concern that cracking developing from multiple directions interfere with each other, causes three-dimensional deviations, and advances, and satisfactory fractured surfaces cannot be obtained since multiple breaking start points are present in the V groove portions 17.

As a fracturing method according to the present embodiment, a method of curbing such three-dimensional deviations is used.

In other words, as the fracturing method according to the present invention, a method of forming stress concentration portions 19 that serve as breaking start points in the V groove portions 17 (groove portions) of the large end portion 5 as illustrated in FIGS. 2 to 4 and fracturing the large end portion 5 is used.

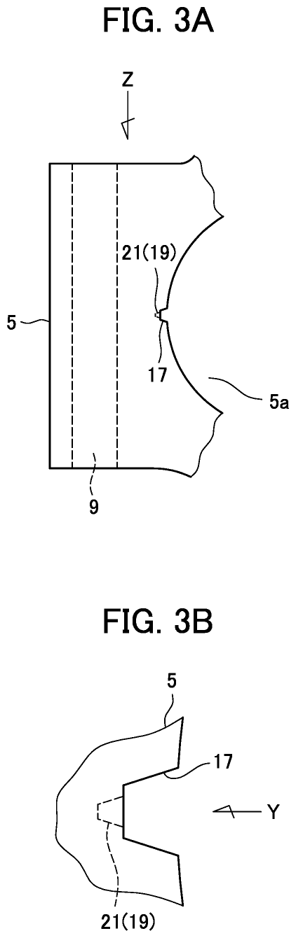

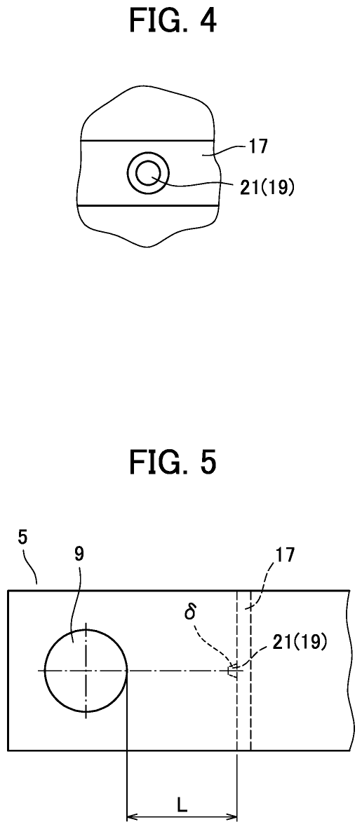

Positions on which a stress is caused to concentrate when the fracturing of the large end portion 5 is started are specified as illustrated in FIGS. 3A, 3B, and 4, and the stress concentration portions 19 are formed at bottom portions of the V groove portions 17 corresponding to the specified positions.

Since the large end portion 5 of the workpiece B includes the crank pin hole 5a at the center thereof and includes the bolt holes 9 on both sides of the crank pin hole 5a, the points on which a stress is caused to concentrate when the fracturing of the large end portion 5 of the con-rod 1 is started are specified at the bottom portions of the V groove portions 17 corresponding to “L (minimum)”, points at which distances between the inner circumferential surface of the crank pin hole 5a and the inner circumferential surfaces of the bolt holes 9 are the shortest as represented by “δ” illustrated in FIG. 5.

The stress concentration portions 19 are formed at the thus specified bottom portions of the V groove portions 17 corresponding to “δ” as illustrated in FIGS. 2 to 5. The stress concentration portions 19 are formed by significantly small recessed portions, here conical trapezoidal recessed portions 21. It is a matter of course that the shape of the stress concentration portions 19 is not limited to the conical trapezoid and may be another shape.

At the recessed portions 21 in the groove portions 17, cracking is caused to occur earliest from the recessed portions 21 located at the specific positions δ on which a stress is caused to concentrate when the fracturing of the large end portion 5 is started. In this manner, cracking occurs from each portion of the groove portions 17 in order, fracturing occurs between the main body portion 15a and the cap portion 15b, and the main body portion 15a and the cap portion 15b are split while forming satisfactory fractured surfaces.

Next, the fracturing method of splitting the workpiece B into the main body portion 15a and the cap portion 15b from the V groove portions 17 will be described. First, the workpiece B that is a semi-finished product of the con-rod 1 illustrated in FIG. 2 is prepared.

As illustrated in FIGS. 2 to 5, the workpiece B includes the pair of V groove portions 17 at facing positions in the inner circumferential surface of the crank pin hole 5a. Also, the recessed portions 21 (stress concentration portions 19) are formed at the positions δ in the V groove portions 17 on which a stress is caused to concentrate. It is a matter of course that the pair of bolt holes 9 are disposed on both sides of the crank pin hole 5a.

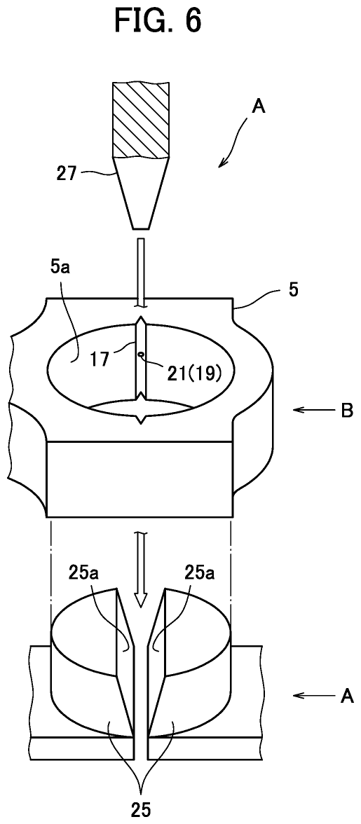

Then, the workpiece B is set in the inner diameter expansion device A that is a fracturing machine as illustrated in FIG. 6, and a process of fracturing the large end portion 5 of the workpiece B is initiated.

Here, the inner diameter expansion device A includes a pair of pressurizing jigs 25 that has a half-split shape in accordance with the crank pin hole 5a, for example, and can be displaced in a pair of contact/separation directions, a wedge portion 27 that push-opens the pair of pressurizing jigs 25, and an actuator (not illustrated) that drives the wedge portion 27. Moreover, tapered surfaces 25a into which the wedge portion 27 is inserted are formed on adjacent side surfaces of the pressurizing jigs 25.

The crank pin hole 5a of the large end portion 5 of the workpiece B is fitted to the pressurizing jigs 25 of the inner diameter expansion device A. It is a matter of course that the large end portions 5 are fitted to the pressurizing jigs 25 in accordance with the fractured position of the large end portion 5. Note that the piston pin hole 3a of the small end portion 3 is fitted to a pin (not illustrated).

In this manner, the workpiece B is set in the inner diameter expansion device A.

Thereafter, the actuator is caused to operate to cause the wedge portion 27 to pressure-fit between the tapered surfaces 25a of the pressurizing jigs 25.

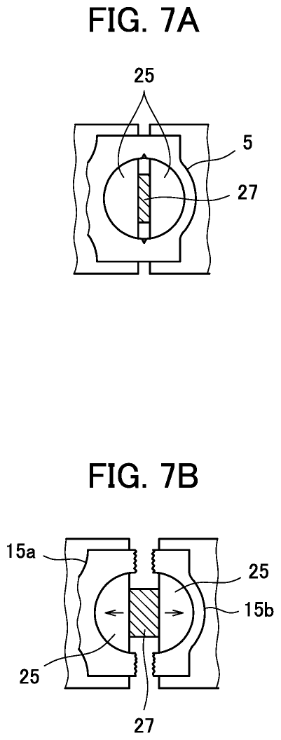

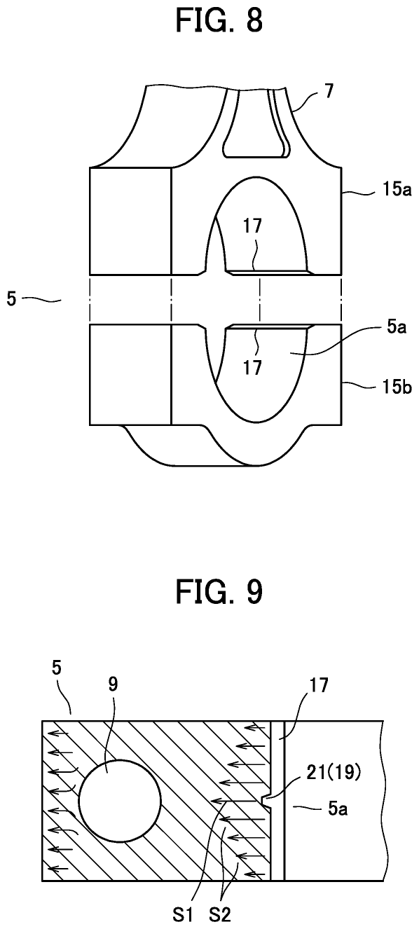

In this manner, a load is applied to the large end portion 5 in a direction in which the crank pin hole 5a is expanded, and the fracturing of the large end portion 5 is started. In this manner, the large end portion 5 is fractured from each of the V groove portions 17 as illustrated in FIGS. 7A and 7B and is split into the main body portion 15a and the cap portion 15b as illustrated in FIG. 8.

When the fracturing is started, each of the recessed portions 21 serves as the earliest breaking start point, and cracking occurs therefrom along the fractured position a when the fracturing of the large end portion 5 is started as illustrated in FIG. 9 since the recessed portions 21 that serve as the stress concentration portions 19 are formed in advance at the positions δ corresponding to the points on which a stress is caused to concentrate in the bottom portions of the V groove portions 17 of the large end portion 5 when the fracturing is started. “S1” in FIG. 8 indicates the cracking occurring earliest. The cracking S1 advances earliest up to the finally fractured position of the large end portion 5.

Cracking develops in order from each portion of the V groove portions 17 as illustrated as “S2” in FIG. 9 with the advancement of the cracking S1 and advances up to the finally fractured position of the large end portion 5. In this manner, advancement of cracking with developing cracking interfering with each other is curbed.

In other words, cracking from the V groove portions 17 does not cause interference and satisfactorily advances up to the finally fractured position. In this manner, three-dimensional deviations of the cracking S1 and S2 are curbed.

Therefore, the workpiece B that is a con-rod 1 can be fractured while forming satisfactory fractured surfaces capable of curbing three-dimensional deviations by the fracturing method of providing the recessed portions 21 that serve as the stress concentration portions 19 in the bottom portions of the V groove portions 17 that serve as the groove portions and causing cracking earliest from the recessed portions 21. Furthermore, it is only necessary to form the stress concentration portions 19 at the bottom portions of the V groove portions 17 that can be easily worked, which is simple.

Such a fracturing method is effective for fracturing with a requirement of high precision, that is, fracturing of a metal component form the V groove portions 17 of the through hole or fracturing of the large end portion 5 of the con-rod 1 from the V groove portion 17.

Furthermore, it is possible to cause cracking to advance earliest from specific positions in the V groove portions 17 using the existing bolt holes 9, by specifying the positions δ at which the distances between the bolt holes 9 and the V groove portions 17 are the shortest as the positions on which a stress is caused to concentrate and forming the recessed portions 21 that serve as the stress concentration portions at the bottom portions of the V groove portions 17 corresponding to the specified position. Moreover, it is only necessary to form the recessed portions 21 in the bottom portions of the V groove portions 17 that can be easily worked for the stress concentration portions 19, which is easy and requires less burden in terms of costs.

On the other hand, if the splitting is ended, then the workpiece B is finished.

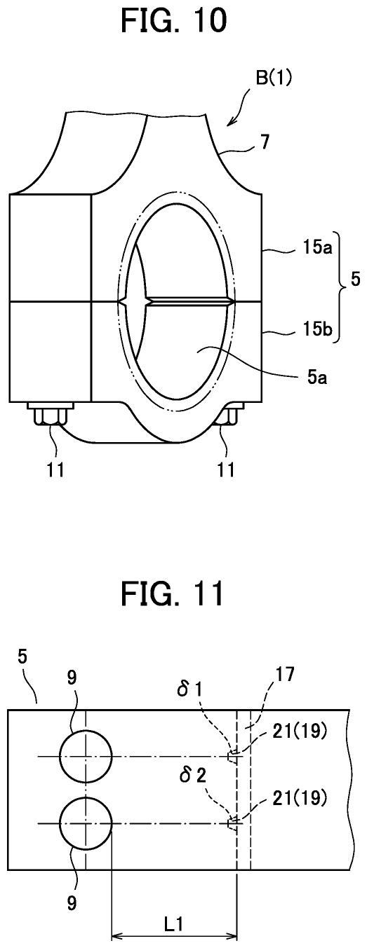

To do this, irregularity generated in the fractured surface of the main body portion 15a and irregularity generated in the fractured surface of the cap portion 15b are used for positioning first to achieve the original state again as illustrated in FIG. 10.

In other words, the irregularity generated in each fractured surface is used for positioning to assemble the cap portion 15b with the main body portion 15a. Then, the cap portion 15b is fastened to the main body portion 15a with the con-rod bolts 11 in the precisely positioned state.

Thereafter, various kinds of finishing such as machine working, for example, is performed on the inner circumferential surface of the crank pin hole 5a as illustrated by the two-dotted dashed line in FIG. 10, to cut the inner circumferential surface of the crank pin hole 5a as illustrated in the two-dotted dashed line in FIG. 10 and finish the inner circumferential surface with no irregularity or work an oil hole for the crank pin hole 5a. The con-rod 1 with a smooth inner circumferential surface illustrated in FIG. 1 as a product is produced by performing such various kinds of finishing on the workpiece B. Note that “la” in FIG. 1 represents the finished inner circumferential surface of the crank pin hole 5a.

FIG. 11 illustrates a second embodiment of the present invention.

An exemplary case will be described, in which the present embodiment is applied to a con-rod 1 in which a plurality of bolt holes 9 are disposed in an aligned manner in the axial direction of a crank pin hole 5a, for example, two pairs of bolt holes 9 are provided to be located on sides of the crank pin hole 5a instead of the con-rod 1 in which a pair of bolt holes 9 are provided to be located on sides of the crank pin hole 5a as in the first embodiment.

In other words, according to the present embodiment, recessed portions 21 that serve as the stress concentration portions 19 are formed at bottom portions of V groove portions 17 corresponding to points at which distances between the bolt holes 9 and the V groove portions 17 are the shortest L1 as represented by “δ1 and δ2” in FIG. 11.

Effects similar to those in the first embodiment are achieved even with the con-rod 1 including the plurality of bolt holes (one side) by forming the recessed portions 21 in accordance with the positions of the bolt holes 9 in this manner. It is a matter of course that the same applies to a case in which three or more pairs of bolt holes 9 are provided.

However, the same reference signs are applied to the same portions as those in the aforementioned first embodiment in FIG. 11, and description thereof will be omitted.

Note that the present invention is not limited to the aforementioned embodiments and may be implemented with various modifications without departing from the gist of the present invention. Although the con-rod has been exemplified as a metal component in the aforementioned embodiments, for example, the present invention is not limited thereto and may be applied to fracturing of other components such as a cylinder block or a cylinder head.

### EXPLANATION OF REFERENCE SIGNS

1 Con-rod (connecting rod)
5 Large end portion
5a Crank pin hole (through hole)
17 V groove portion (groove portion)
21 Recessed portion (stress concentration portion)
A Inner diameter expansion device
B Workpiece (metal component)
δ, δ1, δ2 Position on which stress is caused to concentrate

1. A method for fracturing a metal component in which a through hole is included, and groove portions that continue from a first open end to a second open end of the through hole are formed at facing positions in an inner circumferential surface of the through hole, such that the metal component is able to be fractured from the groove portions, the method comprising:
specifying positions, on which a stress is to concentrate when fracturing of the metal component is started, in the groove portions of the metal component;
forming stress concentration portions at positions in bottom portions of the groove portions corresponding to the specified positions such that the specified positions in the groove portions are caused to serve as breaking start points; and
causing cracking earlier at the stress concentration portions in the groove portions than at each portion of the groove portions when the fracturing of the metal component is started and causing cracking to develop from each portion of the groove portions.

2. The method for fracturing a metal component according to claim 1, wherein the stress concentration portion is formed by a recessed portion.

3. A method for fracturing a connecting rod, which is performed on a connecting rod that includes a large end portion including a through hole, in which groove portions that continue from a first open end to a second open end of the through hole are formed at facing positions in an inner circumferential surface of the through hole, such that the large end portion is able to be fractured from the groove portions, the method comprising:
specifying positions, on which a stress is to concentrate when fracturing of the large end portion is started, in the groove portions of the large end portion;
forming stress concentration portions at positions in bottom portions of the groove portions corresponding to the specified positions such that the specified positions in the groove portions are caused to serve as breaking start points; and
causing cracking earlier at the stress concentration portions in the groove portions than at each portion of the groove portions when the fracturing of the large end portion is started and causing cracking to develop from each portion of the groove portions.

4. The method for fracturing a connecting rod according to claim 3,
wherein the large end portion has bolt holes extending in a direction perpendicularly intersecting the through hole on sides of the through hole, and
the stress concentration portions are formed at positions in the bottom portions of the groove portions corresponding to points at which distances between the bolt holes and the groove portions are the shortest.

5. The method for fracturing a connecting rod according to claim 4,
wherein the plurality of bolt holes are disposed in an aligned manner in an axial direction of the through hole, and
each of the stress concentration portions is formed at a position in the bottom portion of the groove portion corresponding to each point at which the distance between each of the bolt holes and the groove portion is the shortest.

6. The method for fracturing a connecting rod according to claim 5, wherein the stress concentration portions are formed by recessed portions.

7. The method for fracturing a connecting rod according to claim 4, wherein the stress concentration portions are formed by recessed portions.

8. The method for fracturing a connecting rod according to claim 3, wherein the stress concentration portions are formed by recessed portions.
